(19) United States
(12) Patent Application Publication
(10) Pub. No.: US 2019/0334210 A1
(43) Pub. Date: Oct. 31, 2019

(54) SECONDARY BATTERY

(71) Applicant: Murata Manufacturing Co., Ltd., Nagaokakyo-shi (JP)

(72) Inventor: Yasuhiro Matsuzaki, Nagaokakyo-shi (JP)

(21) Appl. No.: 16/505,976

(22) Filed: Jul. 9, 2019

Related U.S. Application Data
(63) Continuation of application No. PCT/JP2018/004409, filed on Feb. 8, 2018.

(30) Foreign Application Priority Data
Feb. 22, 2017 (JP) 2017-031346

(51) Int. Cl. H01M 10/0585; H01M 10/02; H01M 10/0525

(52) U.S. Cl. CPC H01M 10/0585; H01M 10/0525; H01M 10/02

(57) ABSTRACT

A secondary battery is provided that includes an electrode assembly with a positive electrode, a negative electrode, and a separator disposed therebetween; and an electrolyte. The electrode assembly and the electrolyte are accommodated in an exterior body with the electrode assembly having a planar stacked structure in which electrode configuration layers including the positive electrode, the negative electrode, and the separator are planarly stacked in a sectional view. In addition a cut-away is provided in a planar view and fixing members are provided for fixing at least a cut-away side surface of the electrode assembly that forms the cut-away and a uncut-away side surface of the electrode assembly that opposes the cut-away side surface and forms a portion other than the cut-away portion.

### CROSS REFERENCE TO RELATED APPLICATIONS

The present application is a continuation of PCT/JP2018/004409 filed Feb. 8, 2018, which claims priority to Japanese Patent Application No. 2017-031346, filed Feb. 22, 2017, the entire contents of each of which are incorporated herein by reference.

### TECHNICAL FIELD

The present disclosure relates to a secondary battery.

### BACKGROUND

Secondary batteries that can be repeatedly charged and discharged have been used for various applications. For example, the secondary battery is used as a power source for electronic devices such as smartphones and laptop computers.

In recent years, with the increasing demand for thinner and smaller electronic devices, there has been a demand for thinner, smaller, and higher capacity secondary batteries. In order to meet such requirements, Patent Document 1 (identified below) discloses that an electrode assembly as a constituent element of a secondary battery has a planar stacked structure in which a plurality of electrode configuration layers including a positive electrode, a negative electrode, and a separator is planarly stacked in a sectional view, and has a dimple part (i.e., a cut-away portion) in a planar view.

Patent Document 1: Japanese Patent Application Laid-Open No. 2015-536036.

### SUMMARY OF THE INVENTION

Here, the present inventors have found out that the following phenomena occurs in the process of enclosing a planar stacked structure electrode assembly 100′ having a cut-away portion 30′ in a planar view in an exterior body 200′ to form a secondary battery 300′ (see FIG. 10). Specifically, in the planar stacked structure electrode assembly 100′ having the cut-away portion 30′ in a planar view, the strength of an end portion region 70′ of the electrode assembly 100′ forming the cut-away portion 30′ is not relatively high due to the shape, whereby the end portion region 70′ may be locally bent during the production. The occurrence of local bending in the end portion region 70′ makes it difficult to achieve the connection among the layers of the positive electrode, the negative electrode, and the separator interposed between the positive electrode and the negative electrode, which form the electrode assembly. Therefore, there is a possibility that the secondary battery 300′ to be obtained cannot exhibit suitable battery characteristics.

Accordingly, the exemplary embodiments of the present disclosure have been devised in view of such circumstances. Specifically, an object of the present invention is to provide a secondary battery configured to suitably suppress local bending that occurs in a planar stacked structure electrode assembly having a cut-away portion in a planar view.

In order to achieve the above-identified objective, an exemplary embodiment of the present disclosure provides a secondary battery that includes an electrode assembly including a positive electrode, a negative electrode, and a separator disposed between the positive electrode and the negative electrode; and an electrolyte. In this aspect, the electrode assembly and the electrolyte are accommodated in an exterior body, where the electrode assembly has a planar stacked structure in which a plurality of electrode configuration layers including the positive electrode, the negative electrode, and the separator is planarly stacked in a sectional view, and has a cut-away portion in a planar view. Moreover, fixing members are provided for fixing at least a cut-away side surface of the electrode assembly which forms the cut-away portion and a uncut-away side surface of the electrode assembly which is opposed to the cut-away side surface and forms a portion other than the cut-away portion.

According to an exemplary embodiment of the present invention, local bending that occurs in a planar stacked structure electrode assembly having a cut-away portion in a planar view can be suitably suppressed.

### BRIEF DESCRIPTION OF DRAWINGS

FIG. 1A is a plan view schematically illustrating an electrode assembly as an element of a secondary battery according to an exemplary embodiment of the present invention.

FIG. 1B is a perspective view schematically illustrating the electrode assembly as the element of the secondary battery according to an exemplary embodiment of the present invention.

FIG. 2A is a plan view schematically illustrating an electrode assembly of another exemplary embodiment.

FIG. 2B is a perspective view schematically illustrating the electrode assembly of another exemplary embodiment.

FIG. 3A is a plan view schematically illustrating an electrode assembly of still another exemplary embodiment.

FIG. 3B is a perspective view schematically illustrating the electrode assembly of still another exemplary embodiment.

FIG. 4A is a plan view schematically illustrating an electrode assembly of still another exemplary embodiment.

FIG. 4B is a perspective view schematically illustrating the electrode assembly of still another exemplary embodiment.

FIG. 4C is a plan view schematically illustrating a modification of FIGS. 4A and 4B.

FIG. 4D is a plan view schematically illustrating a modification of FIGS. 4A and 4B.

FIG. 4E is a plan view schematically illustrating an embodiment in which the exemplary embodiment illustrated in FIGS. 3A and 3B is combined with the exemplary embodiment illustrated in FIGS. 4A and 4B.

FIG. 5A is a plan view schematically illustrating an exemplary embodiment in which at least two fixing member bands extending in substantially the same direction are provided.

FIG. 5B is a plan view schematically illustrating an exemplary embodiment in which at least two fixing member bands (corresponding to fixing members in a continuous form) extending in substantially the same direction are provided.

FIG. 6 is a plan view schematically illustrating an electrode assembly configured to have a cut-away portion of another exemplary embodiment.

FIG. 7A is a plan view schematically illustrating an exemplary embodiment in which one fixing member band and the other fixing member band are provided substantially in parallel.

FIG. 7B is a plan view schematically illustrating another exemplary embodiment in which one fixing member band and the other fixing member band are provided substantially in parallel.

FIG. 8A is a cross-sectional view schematically illustrating a formation of a fixing member in a discontinuous form (in an insulating tape form).

FIG. 8B is a cross-sectional view schematically illustrating the formation of the fixing member in a continuous form (in an insulating tape form).

FIG. 9 is a cross-sectional view schematically illustrating a specific configuration of an electrode assembly.

FIG. 10 is a pattern diagram illustrating a technical problem found by the present inventors.

### DETAILED DESCRIPTION

According to the present disclosure, a secondary battery is provided. Specifically, the term “secondary battery” used herein means a battery that can be repeatedly charged and discharged. Therefore, the secondary battery of the present disclosure is not excessively limited by its name, and for example, an electric storage device and the like can be included in the subject of the present invention. The term “planar view” as used herein means a state when an object is viewed from the upper side or the lower side along the thickness direction based on the stacking direction of the electrode materials forming the secondary battery. The term “sectional view” used herein is a state when viewed from a direction substantially perpendicular to the thickness direction based on the stacking direction of the electrode materials forming the secondary battery. The secondary battery has a structure in which an electrode assembly and an electrolyte are accommodated and enclosed in an exterior body. In the present disclosure, the electrode assembly is based on the premise that it has a planar stacked structure in which a plurality of electrode configuration layers including a positive electrode, a negative electrode, and a separator is stacked. Further, the exterior body may take the form of a conductive hard case or a flexible case (such as a pouch). When the form of the exterior body is a flexible case (such as a pouch), each of a plurality of positive electrodes is connected to the positive electrode external terminal via the positive electrode collector lead. The positive electrode external terminal is fixed to the exterior body by a seal portion, and the seal portion prevents leakage of the electrolyte. Similarly, each of a plurality of negative electrodes is connected to a negative electrode external terminal via a negative electrode collector lead. The negative electrode external terminal is fixed to the exterior body by a seal portion, and the seal portion prevents leakage of the electrolyte. Although there is no limitation thereto, the positive electrode collector lead connected to each of the plurality of positive electrodes may have a function of the positive electrode external terminal, and the negative electrode collector lead connected to each of the plurality of negative electrodes may have a function of the negative electrode external terminal. When the form of the exterior body is a conductive hard case, each of the plurality of positive electrodes is connected to the positive electrode external terminal via the positive electrode collector lead. The positive electrode external terminal is fixed to the exterior body by a seal portion, and the seal portion prevents leakage of the electrolyte.

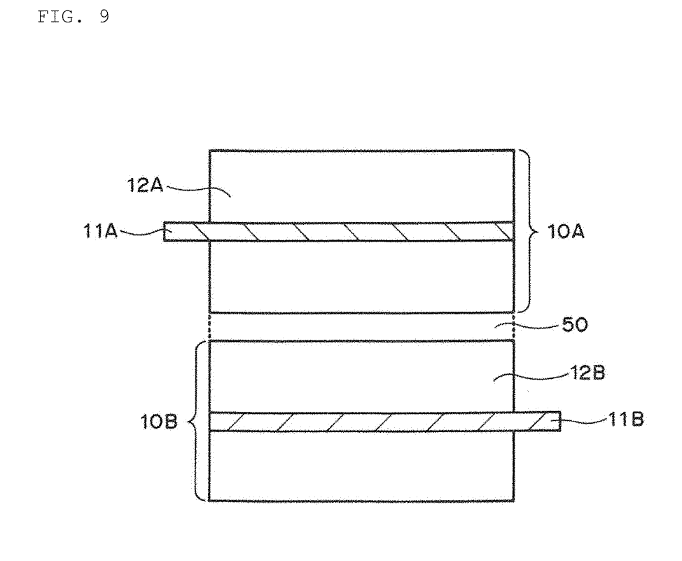

As generally shown in FIG. 9, a positive electrode 10A is composed of at least a positive electrode current collector 11A and a positive electrode material layer 12A, and the positive electrode material layer 12A is provided on at least one surface of the positive electrode current collector 11A. An extension tab at the positive electrode side is positioned at a location where the positive electrode material layer 12A is not provided in the positive electrode current collector 11A, that is, an end portion of the positive electrode current collector 11A. The positive electrode material layer 12A contains a positive electrode active material as an electrode active material. Moreover, a negative electrode 10B is composed of at least a negative electrode current collector 11B and a negative electrode material layer 12B, and the negative electrode material layer 12B is provided on at least one surface of the negative electrode current collector 11B. An extension tab at the negative electrode side is positioned at a location where the negative electrode material layer 12B is not provided in the negative electrode current collector 11B, that is, an end portion of the negative electrode current collector 11B. The negative electrode material layer 12B contains a negative electrode active material as an electrode active material.

The positive electrode active material contained in the positive electrode material layer 12A and the negative electrode active material contained in the negative electrode material layer 12B are substances directly involved in the transfer of electrons in the secondary battery and are main substances of the positive and negative electrodes which are responsible for charging and discharging, namely a battery reaction. More specifically, ions are generated in the electrolyte by the positive electrode active material contained in the positive electrode material layer 12A and the negative electrode active material contained in the negative electrode material layer 12B, and the ions move between the positive electrode 10A and the negative electrode 10B and the electrons are transferred, whereby charging and discharging are performed. It is preferable that the positive electrode material layer 12A and the negative electrode material layer 12B are particularly layers configured for occluding and releasing lithium ions. In other words, a secondary battery is provided in an exemplary aspect in which lithium ions move between the positive electrode 10A and the negative electrode 10B through an electrolyte, thereby charging and discharging the battery. When lithium ions are involved in charging and discharging, the secondary battery corresponds to a so-called lithium ion battery.

The positive electrode active material of the positive electrode material layer 12A is made of, for example, a granular material, and it is preferable that a binder (also referred to as “binding material”) is contained in the positive electrode material layer 12A in order to maintain a sufficient contact between particles and the shape of the particles. Further, a conductive auxiliary agent may be contained in the positive electrode material layer 12A in order to facilitate transmission of electrons promoting the battery reaction. Similarly, when the negative electrode active material of the negative electrode material layer 12B is made of, for example, a granular material, a binder is preferably contained in order to maintain a sufficient contact between particles and the shape of the particles, and a conductive auxiliary agent may be contained in the negative electrode material layer 12B in order to facilitate transmission of electrons promoting the battery reaction. As described above, since a plurality of components is contained, the positive electrode material layer 12A and the negative electrode material layer 12B can also be referred to as positive electrode mixture layer and negative electrode mixture layer respectively.

Preferably, the positive electrode active material is a material contributing to occlusion and release of lithium ions. From these points of view, it is preferable that the positive electrode active material is, for example, a lithium-containing composite oxide. More specifically, it is preferable that the positive electrode active material is a lithium transition metal composite oxide which contains lithium and at least one transition metal selected from the group consisting of cobalt, nickel, manganese, and iron. That is, in the positive electrode material layer 12A of the secondary battery, the lithium transition metal composite oxide is preferably contained as the positive electrode active material. Examples of the positive electrode active material may include lithium cobaltate, lithium nickelate, lithium manganate, lithium iron phosphate, or materials in which a part of the transition metal of these is substituted with another metal. Although the positive electrode active material may be contained singly or two or more kinds thereof may be contained. In a refinement of the exemplary embodiment, the positive electrode active material contained in the positive electrode material layer 12A is lithium cobaltate.

The binder which can be contained in the positive electrode material layer 12A is not particularly limited, but examples thereof include at least one selected from the group consisting of polyvinylidene fluoride, a vinylidene fluoride-hexafluoropropylene copolymer, a vinylidene fluoride-tetrafluoroethylene copolymer, and polytetrafluoroethylene. The conductive auxiliary agent which can be contained in the positive electrode material layer 12A is not particularly limited, but examples thereof include at least one selected from the group consisting of carbon black such as thermal black, furnace black, channel black, ketjen black, and acetylene black; carbon fibers such as graphite, carbon nanotube, and vapor-grown carbon fiber; metal powders such as copper, nickel, aluminum, and silver; and polyphenylene derivatives. For example, the binder of the positive electrode material layer 12A may be polyvinylidene fluoride. Although it is merely an example, the conductive auxiliary agent of the positive electrode material layer 12A is carbon black. Further, the binder and the conductive auxiliary agent in the positive electrode material layer 12A may be a combination of polyvinylidene fluoride and carbon black.

In an exemplary aspect, the negative electrode active material preferably is a material contributing to occlusion and release of lithium ions. From these points of view, as the negative electrode active material, for example, various carbon materials, oxides, or lithium alloys are preferred.

Examples of the various carbon materials for the negative electrode active material include graphite (natural graphite and artificial graphite), hard carbon, soft carbon, and diamond-like carbon. Particularly, graphite is preferred because it has high electron conductivity and excellent adhesion to the negative electrode current collector 11B and the like. Examples of the oxide of the negative electrode active material include at least one selected from the group consisting of silicon oxide, tin oxide, indium oxide, zinc oxide, and lithium oxide. The lithium alloy of the negative electrode active material may be any metal as long as the metal can be alloyed with lithium, and the lithium alloy may be, for example a binary, ternary or higher alloy of a metal such as Al, Si, Pb, Sn, In, Bi, Ag, Ba, Ca, Hg, Pd, Pt, Te, Zn or La and lithium. It is preferable that the structural form of the oxide is amorphous. This is because degradation due to nonuniformity such as grain boundaries or defects is unlikely to be caused. Although it is merely an example, the negative electrode active material of the negative electrode material layer 12B may be artificial graphite.

The binder which can be contained in the negative electrode material layer 12B is not particularly limited, but examples thereof include at least one kind selected from the group consisting of styrene-butadiene rubber, polyacrylic acid, polyvinylidene fluoride, polyimide-based resin, and polyamideimide-based resin. For example, the binder contained in the negative electrode material layer 12B may be a styrene-butadiene rubber. The conductive auxiliary agent which can be contained in the negative electrode material layer 12B is not particularly limited, but examples thereof include at least one selected from the group consisting of carbon black such as thermal black, furnace black, channel black, ketjen black, and acetylene black; carbon fibers such as graphite, carbon nanotube, and vapor-grown carbon fiber; metal powders such as copper, nickel, aluminum, and silver; and polyphenylene derivatives. It is to be noted that the negative electrode material layer 12B may contain a component caused by a thickener component (e.g., carboxymethyl cellulose) used at the time of producing the battery.

Although it is merely an example, the negative electrode active material and the binder in the negative electrode material layer 12B can be a combination of artificial graphite and styrene-butadiene rubber.

The positive electrode current collector 11A and the negative electrode current collector 11B used for the positive electrode 10A and the negative electrode 10B are members that contribute to the collection and supply of electrons generated in the active material by the battery reaction. Each of the current collectors may be a sheet-like metal member and may have a porous or perforated form. For example, each of the current collectors may be a metal foil, a punching metal, a net, an expanded metal, or the like. The positive electrode current collector 11A used for the positive electrode 10A is preferably made of a metal foil containing at least one selected from the group consisting of aluminum, stainless steel, and nickel, and can be, for example, an aluminum foil. On the other hand, the negative electrode current collector 11B used for the negative electrode 10B is preferably made of a metal foil containing at least one selected from the group consisting of copper, stainless steel, and nickel, and may be, for example, a copper foil.

A separator 50 used for the positive electrode 10A and the negative electrode 10B is a member provided from the viewpoints of the prevention of short circuit due to contact between the positive and negative electrodes and the holding of the electrolyte and the like. In other words, the separator 50 is a member that passes ions while preventing electronic contact between the positive electrode 10A and the negative electrode 10B. Preferably, the separator 50 is a porous or microporous insulating member and has a film form due to its small thickness. Although it is merely an example, a microporous membrane made of polyolefin may be used as the separator. In this respect, the microporous membrane used as the separator 50 may contain, for example, only polyethylene (PE) or only polypropylene (PP) as polyolefin. Further, the separator 50 may be a stacked body composed of a microporous membrane made of PE and a microporous membrane made of PP. The surface of the separator 50 may be covered with an inorganic particle coating layer and/or an adhesive layer. The surface of the separator may have adhesive properties. It is to be noted that, the separator 50 should not be limited, particularly by its name, and may be a solid electrolyte, a gel electrolyte, an insulating inorganic particle or the like, which have a similar function. It is to be noted that, from the viewpoint of further improving the handling of the electrodes, it is preferable that the separator 50 is adhered to the electrodes (the positive electrode 10A/the negative electrode 10B). The adhesion between the separator 50 and the electrodes can be achieved by using an adhesive separator as the separator 50, applying and/or thermal compression bonding an adhesive binder on the electrode material layers (the positive electrode material layer 12A/the negative electrode material layer 12B). Examples of the adhesive that provides adhesive properties to the separator 50 or the electrode material layers include polyvinylidene fluoride and acrylic adhesives.

When the positive electrode 10A and the negative electrode 10B have a layer capable of occluding and releasing lithium ions, the electrolyte is preferably a nonaqueous-based electrolyte such as an organic electrolyte and/or an organic solvent (i.e., the electrolyte is preferably a nonaqueous electrolyte). In the electrolyte, metal ions released from electrodes (the positive electrode 10A and the negative electrode 10B) are present, and thus the electrolyte helps the transfer of metal ions in the battery reaction.

The nonaqueous electrolyte is an electrolyte containing a solvent and a solute. As a specific solvent for the nonaqueous electrolyte, a solvent containing at least a carbonate is preferred. The carbonates may be cyclic carbonates and/or chain carbonates. Although not particularly limited, examples of the cyclic carbonates include at least one kind selected from the group consisting of propylene carbonate (PC), ethylene carbonate (EC), butylene carbonate (BC), and vinylene carbonate (VC). Examples of the chain carbonates include at least one kind selected from the group consisting of dimethyl carbonate (DMC), diethyl carbonate (DEC), ethyl methyl carbonate (EMC), and dipropyl carbonate (DPC). Although it is merely an example, a combination of cyclic carbonates and chain carbonates is used as the nonaqueous electrolyte, and, for example, a mixture of ethylene carbonate and diethyl carbonate may be used. As a solute of a specific nonaqueous electrolyte, for example, a Li salt such as LiPF₆ or LiBF₄ is preferably used. As a solute of a specific nonaqueous electrolyte, for example, a Li salt such as LiPF₆ and/or LiBF₄ is preferably used.

As the positive electrode collector lead and the negative electrode collector lead, it is possible to use any collector lead used in the field of the secondary battery. The collector leads may be made of a material which can achieve electron transfer, and are made of, for example, a conductive material such as aluminum, nickel, iron, copper, or stainless steel. The positive electrode collector lead is preferably made of aluminum, and the negative electrode collector lead is preferably made of nickel. The form of the positive electrode collector lead or the negative electrode collector lead is not particularly limited, and the form may be, for example, line-shaped or plate-shaped.

Moreover, it is possible to use any external terminal used in the field of the secondary battery. The external terminals can be made of a material which can achieve electron transfer, and are usually made of a conductive material such as aluminum, nickel, iron, copper or stainless steel. An external terminal 5 can be electrically and directly connected to a substrate, or may be electrically and indirectly connected to the substrate via another device. Although there is no limitation thereto, the positive electrode collector lead connected to each of the plurality of positive electrodes can have a function of the positive electrode external terminal, and the negative electrode collector lead connected to each of the plurality of negative electrodes can have a function of the negative electrode external terminal.

In an exemplary aspect, the exterior body can be in the form of a conductive hard case or a flexible case (such as a pouch) as described above.

The conductive hard case is composed of a main body portion and a lid portion. The main body portion is composed of a bottom portion forming the bottom surface of the exterior body and a side portion. The main body portion and the lid portion are sealed after accommodating the electrode assembly, the electrolyte, the collector lead, and the external terminal. The sealing method is not particularly limited, and examples thereof include a laser irradiation method. As a material forming the main body portion and the lid portion, it is possible to use any material which can form a hard case type exterior body in the field of the secondary battery. The material may be any material as long as electron transfer can be achieved, and examples thereof include conductive materials such as aluminum, nickel, iron, copper, and stainless steel. The dimensions of the main body portion and the lid portion are determined mainly according to the dimension of the electrode assembly, and, for example, it is preferable that the electrode assembly has a dimension such that the movement (displacement) of the electrode assembly in the exterior body is prevented when the electrode assembly is accommodated. The movement of the electrode assembly is prevented, whereby the destruction of the electrode assembly is prevented and the safety of the secondary battery is improved.

The flexible case is composed of a flexible sheet. The flexible sheet may have softness enough to achieve bending of the seal portion, and is preferably a plastic sheet. The plastic sheet is a sheet having characteristics in which an external force is applied and removed, and then deformation by the external force is maintained. For example, a so-called laminate film can be used as the plastic sheet. A flexible pouch made of a laminate film can be produced, for example, by superimposing two laminate films and heat-sealing the peripheral portion of the laminate. A film obtained by laminating a metal foil and a polymer film is generally used as the laminate film, and a specific example of the film is a film having a three-layer configuration consisting of an outer layer of polymer film, a metal foil, and an inner layer of polymer film. The outer layer of polymer film serves to prevent permeation of moisture and the like and damage to the metal foil due to contact and the like, and polymers such as polyamide and polyester may be suitably used. The metal foil serves to prevent permeation of moisture and gas, and foils of copper, aluminum, and stainless steel may be suitably used. The inner layer polymer film serves to protect the metal foil from the electrolyte housed inside and also serves to provide a melt seal during heat sealing, and a polyolefin or acid-modified polyolefin may be suitably used.

In consideration of the basic configuration of the secondary battery according to an exemplary embodiment of the present disclosure, a characteristic portion of the secondary battery will be described below.

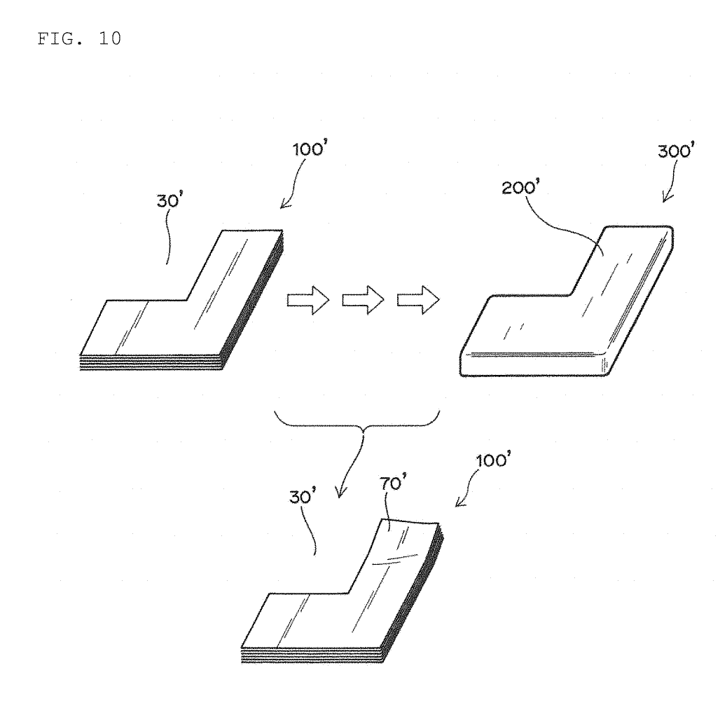

The present inventors have conducted intensive studies in order to solve the technical problem (see FIG. 10) in which, as for a planar stacked structure electrode assembly 100′ configured to have a cut-away portion 30′ in a planar view, local bending occurs in an end portion region 70′ of the electrode assembly 100′ which forms the cut-away portion 30′, and they have developed the secondary battery according to an exemplary embodiment of the present invention.

Hereinafter, the term “cut-away portion” in the present disclosure means a portion in which a part of a rectangular electrode assembly is cut away or removed from a main surface of the rectangular electrode assembly in a planar view, whereby a non-rectangular electrode assembly is formed. The term “fixing member” in the present disclosure means a member for integrally fixing a positive electrode, a negative electrode, and an end portion of a separator exposed at least on a side surface of the electrode assembly. Further, the term “fixing member” in the present disclosure is not particularly limited, and may be a fitting member that can be fitted to an insulating tape-like fixing member and/or the electrode assembly. The term “cut-away side surface” as in the present disclosure means a side surface of a portion of the side surface of the electrode assembly, and the portion forms a cut-away portion in a planar view. The term “uncut-away side surface” in the present disclosure means a side surface of a portion of the side surface of the electrode assembly, and the portion forms a portion other than the cut-away portion in a planar view.

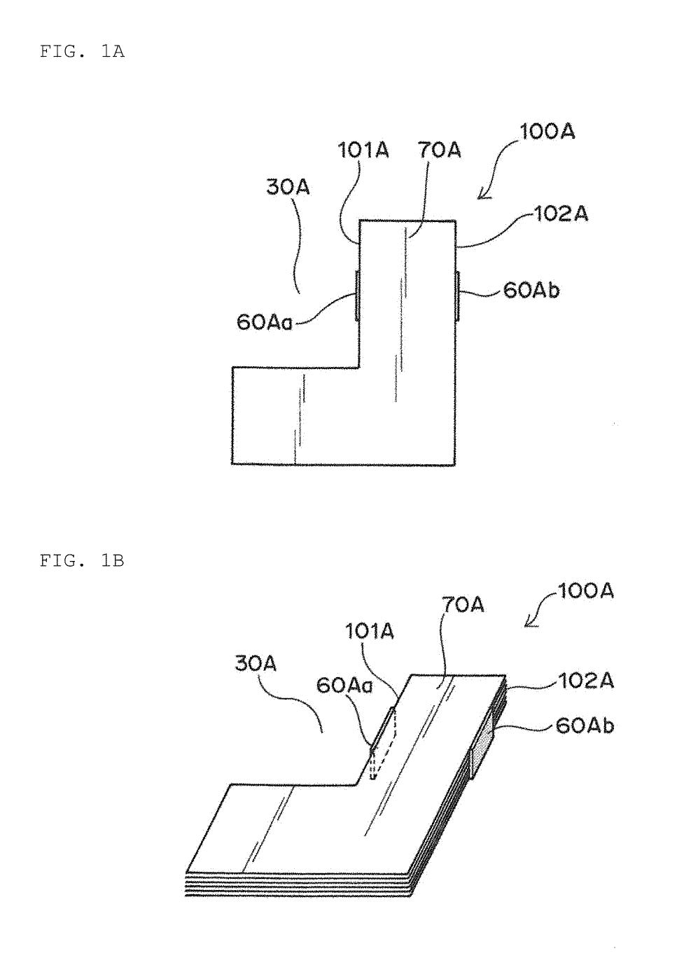

FIG. 1A is a plan view schematically illustrating an electrode assembly which is a constituent element of a secondary battery according to an exemplary embodiment of the present disclosure. FIG. 1B is a perspective view schematically illustrating the electrode assembly which is the constituent element of the secondary battery according to an exemplary embodiment of the present disclosure.

In order to solve the above technical problem, the exemplary embodiment is characterized in that there are provided fixing members 60A (60Aa and 60Ab) for fixing at least a cut-away side surface 101A of an electrode assembly 100A which forms a cut-away portion 30A (i.e., the defined space) as well as a uncut-away side surface 102A of the electrode assembly which is opposed to the cut-away side surface 101A and forms a portion other than the cut-away portion 30A, as illustrated in FIGS. 1A and 1B.

The fixing members 60A (60Aa and 60Ab) are installed, whereby the cut-away side surface 101A and the uncut-away side surface 102A of the electrode assembly 100A, which are opposed to each other, are fixed. Specifically, the end portions of the positive electrode and the negative electrode and the end portion of the separator interposed between the positive electrode and the negative electrode, which are exposed at the cut-away side surface 101A, are integrally fixed by a fixing member 60Aa, and the end portions of the positive electrode and the negative electrode and the end portion of the separator interposed between the positive electrode and the negative electrode, which are exposed at the uncut-away side surface 102A opposed to the cut-away side surface 101A, are integrally fixed by a fixing member 60Ab.

According to the exemplary aspect, the end portions of the positive electrode, the negative electrode, and the separator, which are exposed at both side surfaces, are integrally fixed, so that it is firstly possible to suitably suppress the separation along the stacking direction of layers of the positive electrode, the negative electrode, and the separator, which are exposed at both the cut-away side surface 101A and the uncut-away side surface 102A. The end portions of the positive electrode, the negative electrode, and the separator, which are exposed at both side surfaces, are integrally fixed, so that it is secondly possible to suitably suppress the positional deviation among the layers along the direction substantially perpendicular (substantially horizontal direction) to the stacking direction (substantially vertical direction) of the positive electrode, the negative electrode, and the separator. The separation along the stacking direction of layers is suitably suppressed as described herein and the positional deviation among the layers along the direction substantially perpendicular (substantially horizontal direction) to the stacking direction (substantially vertical direction) is suitably suppressed as also described herein, so that it is possible to suitably maintain the strength of an end portion region 70A of the electrode assembly 100A forming the cut-away portion 30A. The strength of the end portion region 70A of the electrode assembly 100A is suitably maintained, so that it is possible to suitably suppress the occurrence of local bending in the end portion region 70A of the electrode assembly 100A forming the cut-away portion 30A. The occurrence of local bending in the end portion region 70A is suitably suppressed, so that it is possible to suitably maintain the connection among the layers of the positive electrode, the negative electrode, and the separator. Therefore, a secondary battery is obtained by enclosing the electrode assembly 100A, in which the connection among the layers of the positive electrode, the negative electrode, and the separator is suitably maintained, in an exterior body, and the secondary battery can exhibit suitable battery characteristics. On the premise that the strength of the end portion region 70A of the electrode assembly 100A is suitably maintained by the fixing member, the smaller the occupied area of the fixing member with respect to the electrode assembly 100A is, the more the impregnation of the exterior body to be described later (in addition to the electrode assembly 100A) with a predetermined amount of electrolytic solution can be ensured.

In an exemplary embodiment, it is preferable that a fixing member is further provided on parts of main surfaces of an electrode assembly so as to be added to a cut-away side surface and be continuous with the cut-away side surface, and a fixing member is further provided on parts of main surfaces of an electrode assembly so as to be added to a uncut-away side surface and be continuous with the uncut-away side surface.

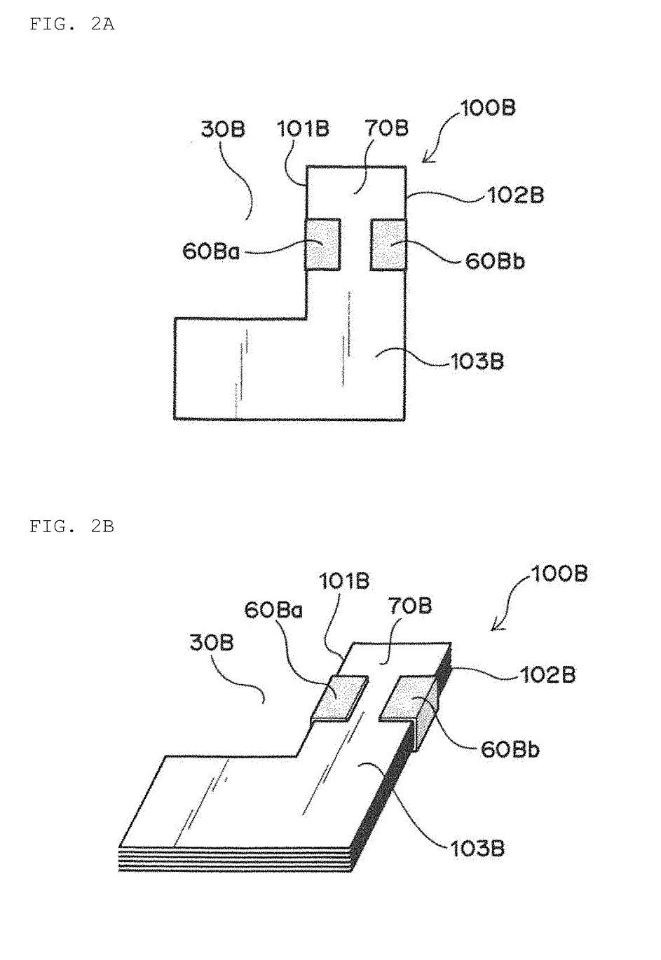

FIG. 2A is a plan view schematically illustrating an electrode assembly of another embodiment. FIG. 2B is a perspective view schematically illustrating the electrode assembly of another embodiment.

As an example of this embodiment, there are the embodiments illustrated in FIGS. 2A and 2B.

As compared with the embodiments illustrated in FIGS. 1A and 1B, the embodiments illustrated in FIGS. 2A and 2B are characterized in that one fixing member 60Ba is further provided on parts of main surfaces 103B of the electrode assembly 100B so as to be added to a cut-away side surface 101B and thus be continuous with the cut-away side surface 101B. As compared with the embodiments illustrated in FIGS. 1A and 1B, the embodiments illustrated in FIGS. 2A and 2B are characterized in that a fixing member 60Bb (as the other fixing member) opposed to the fixing member 60Ba (as the one fixing member) is further provided on parts of main surfaces 103B of the electrode assembly 100B so as to be added to a uncut-away side surface 102B and be continuous with the uncut-away side surface 102B. In the embodiments illustrated in FIGS. 2A and 2B, the fixing member 60Ba for fixing the cut-away side surface 101B and the fixing member 60Bb for fixing the uncut-away side surface 102B are discontinuous through the main surfaces 103B of the electrode assembly 100B.

The fixing member 60Ba is installed, whereby the cut-away side surface 101B of the electrode assembly 100B and parts of the main surfaces 103B of the electrode assembly 100B being continuous with the cut-away side surface 101B are fixed. Further, the fixing member 60Bb is installed, whereby the uncut-away side surface 102B of the electrode assembly 100B and parts of the main surfaces 103B of the electrode assembly 100B being continuous with the uncut-away side surface 102B are fixed. Specifically, the end portions of the positive electrode, the negative electrode, and the separator interposed between the positive electrode and the negative electrode, which are exposed at the cut-away side surface 101B, are integrally fixed by the fixing member 60Ba, and the fixation is performed such that one main surface 103B and the other main surface 103B of the electrode assembly 100B are sandwiched by the fixing member 60Ba. Further, the end portions of the positive electrode, the negative electrode, and the separator interposed between the positive electrode and the negative electrode, which are exposed at the uncut-away side surface 102B, are integrally fixed by the fixing member 60Bb, and the fixation is performed such that one main surface 103B and the other main surface 103B of the electrode assembly 100B are sandwiched by the fixing member 60Bb.

As described above, in the exemplary embodiments illustrated in FIGS. 2A and 2B, in addition to the integral fixation of the end portions of the positive electrode, the negative electrode, and the separator exposed at both the side surfaces by the fixing members 60Ba and 60Bb, the fixation by sandwiching one main surface 103B and the other main surface 103B of the electrode assembly 100B by the fixing members 60Ba and 60Bb is performed. Specifically, the fixation by sandwiching is performed, so that it is firstly possible to suitably suppress the separation along the stacking direction of layers of the positive electrode, the negative electrode, and the separator, which are exposed at both the cut-away side surface 101B and the uncut-away side surface 102B. Further, the fixation by sandwiching is further performed, so that it is secondly possible to suitably suppress the positional deviation among the layers along the direction substantially perpendicular (i.e., substantially horizontal direction) to the stacking direction (i.e., substantially vertical direction) of the positive electrode, the negative electrode, and the separator. The separation along the stacking direction of layers is more suitably suppressed as described herein and the positional deviation among the layers along the direction substantially perpendicular (substantially horizontal direction) to the stacking direction (substantially vertical direction) is more suitably suppressed as also described herein, so that it is possible to more suitably maintain the strength of an end portion region 70A of the electrode assembly 100A forming the cut-away portion 30A. The strength of the end portion region 70A of the electrode assembly 100A is more suitably maintained, so that it is possible to more suitably suppress the occurrence of local bending in the end portion region 70A of the electrode assembly 100A forming the cut-away portion 30A. The occurrence of local bending in the end portion region 70A is more suitably suppressed, so that it is possible to more suitably maintain the connection among the layers of the positive electrode, the negative electrode, and the separator. Therefore, the secondary battery obtained by enclosing the electrode assembly 100A, in which the connection among the layers of the positive electrode, the negative electrode, and the separator is more suitably maintained, in an exterior body can exhibit more suitable battery characteristics.

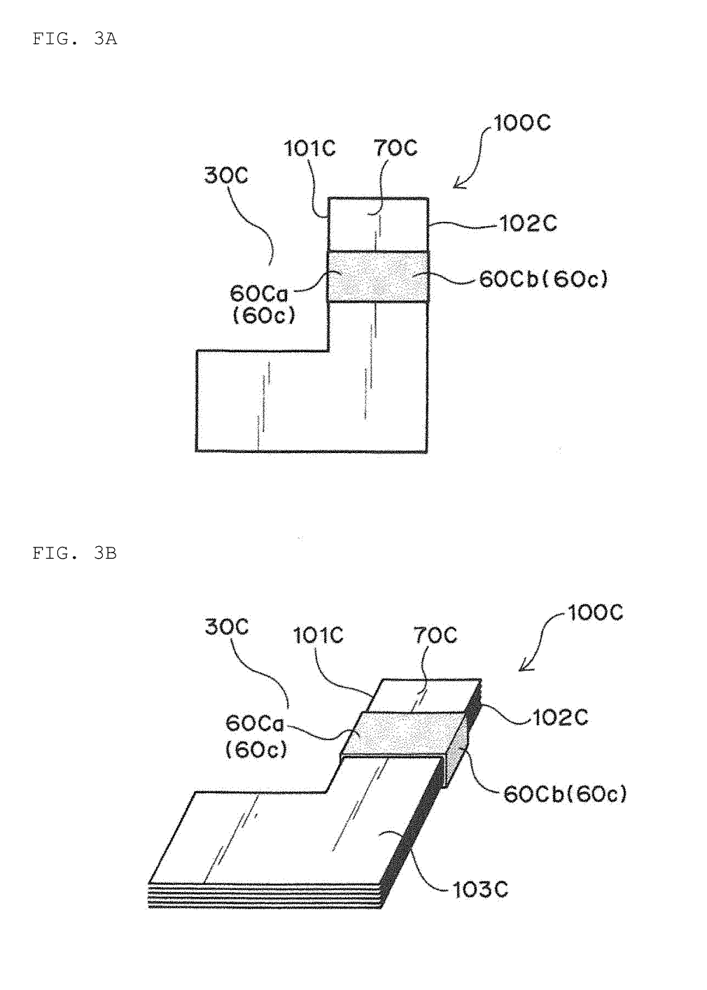

FIG. 3A is a plan view schematically illustrating an electrode assembly of still another embodiment. FIG. 3B is a perspective view schematically illustrating the electrode assembly of still another embodiment.

As another example of this embodiment, there are the embodiments illustrated in FIGS. 3A and 3B.

As compared with the embodiments illustrated in FIGS. 2A and 2B, the exemplary embodiments illustrated in FIGS. 3A and 3B are characterized in that a fixing member 60Ca for fixing a cut-away side surface 101C and a fixing member 60Cb for fixing a uncut-away side surface 102C are continuous through main surfaces 103C of an electrode assembly 100C.

According to the characteristics, in the exemplary embodiments illustrated in FIGS. 3A and 3B, the fixing member 60Ca and the fixing member 60Cb (i.e., fixing members 60C) are provided so as to entirely surround the cut-away side surface 101C, the uncut-away side surface 102C, and the main surfaces 103C of the electrode assembly 100C in a sectional view, as compared with the embodiments illustrated in FIGS. 2A and 2B. As a result, the electrode assembly 100C at a location where the fixing member 60C is provided is entirely surrounded by the fixing member 60C in a sectional view, whereby the fixation of the electrode assembly 100C at the portion can be further enhanced, compared with the embodiments illustrated in FIGS. 2A and 2B.

The electrode assembly is surrounded by the fixing member 60C, so that it is firstly possible to still more suitably suppress the separation along the stacking direction of layers of the positive electrode, the negative electrode, and the separator, which are exposed at both the cut-away side surface 101C and the uncut-away side surface 102C. Further, the electrode assembly is surrounded by the fixing member 60C, so that it is secondly possible to still more suitably suppress the positional deviation among the layers along the direction substantially perpendicular (substantially horizontal direction) to the stacking direction (substantially vertical direction) of the positive electrode, the negative electrode, and the separator. The separation along the stacking direction of layers is still more suitably suppressed as described herein and the positional deviation among the layers along the direction substantially perpendicular (substantially horizontal direction) to the stacking direction (substantially vertical direction) is still more suitably suppressed as also described herein, so that it is possible to still more suitably maintain the strength of an end portion region 70C of the electrode assembly 100C forming the cut-away portion 30C. The strength of the end portion region 70C of the electrode assembly 100C is more suitably maintained, so that it is possible to still more suitably suppress the occurrence of local bending in the end portion region 70C of the electrode assembly 100C forming the cut-away portion 30C. The occurrence of local bending in the end portion region 70C is still more suitably suppressed, so that it is possible to still more suitably maintain the connection among the layers of the positive electrode, the negative electrode, and the separator. Therefore, the secondary battery obtained by enclosing the electrode assembly 100C, in which the connection among the layers of the positive electrode, the negative electrode, and the separator is still more suitably maintained, in an exterior body can exhibit more suitable battery characteristics.

In an exemplary embodiment, at least two fixing member bands composed of fixing members for fixing a cut-away side surface and an uncut-away side surface are provided, and an angle formed between the extending direction of one fixing member band and the extending direction of the other fixing member band is preferably from 60° to 120° in a planar view.

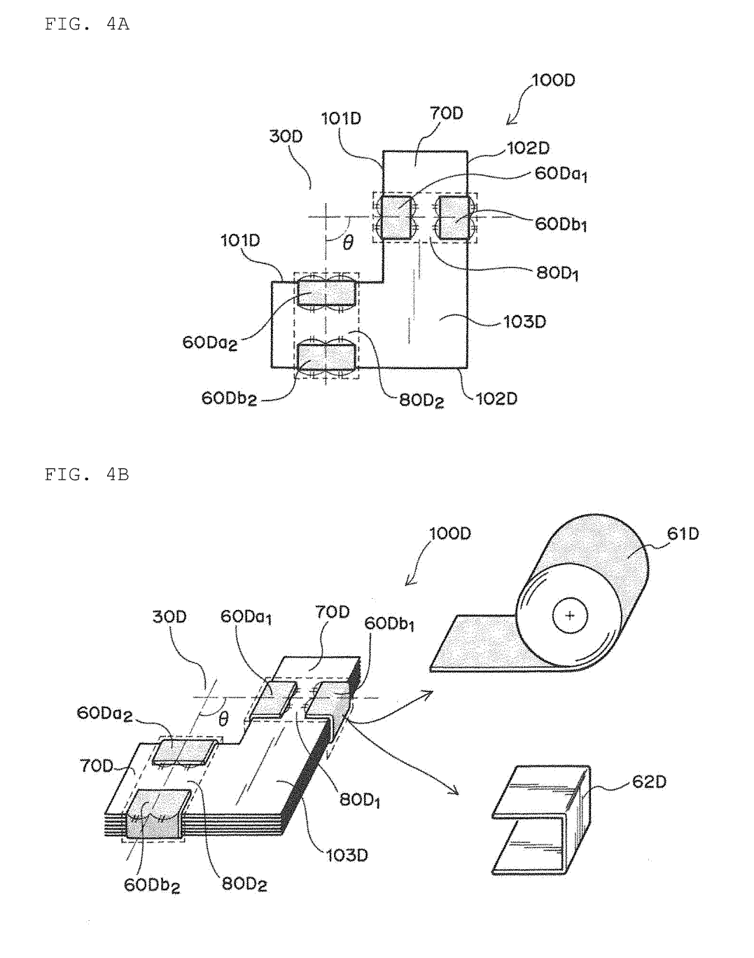

FIG. 4A is a plan view schematically illustrating an electrode assembly of still another embodiment. FIG. 4B is a perspective view schematically illustrating the electrode assembly of still another embodiment.

As an example, in this exemplary embodiment, as illustrated in FIGS. 4A and 4B, there are provided a fixing member band 80D₁ composed of a first fixing member 60Da₁ for fixing a cut-away side surface 101D and a second fixing member 60Db₁ for fixing a uncut-away side surface 102D as well as a fixing member band 80D₂ composed of a third fixing member 60Da₂ for fixing the cut-away side surface 101D and a fourth fixing member 60Db₂ for fixing the uncut-away side surface 102D. An angle θ formed between the extending direction of the fixing member band 80D₁ and the extending direction of the fixing member band 80D₂ is not particularly limited, and it is preferably from 60° to 120° in a planar view.

The term “fixing member band” in the present disclosure means a fixing member in a continuous form which fixes the cut-away side surface 101D and the uncut-away side surface 102D or a band-like fixing member formed of a pair of fixing members in a discontinuous form (or a group of fixing members) (i.e., FIGS. 4A and 4B illustrate a pair of fixing members in a discontinuous form). The term “extending direction of the fixing member band” in the present disclosure means a direction that extends through a middle point of a predetermined side of a fixing member along a side surface of an electrode assembly and a middle point of a side of the fixing member opposed to the predetermined side in a planar view. It should be appreciated that the term “fixing member” in the present disclosure is not particularly limited, and may be a fitting member 62D that can be fitted to an insulating tape-like fixing member 61D and/or an electrode assembly 100D, as illustrated in FIG. 4B.

That is, as compared with the exemplary embodiments illustrated in FIGS. 2A and 2B, this embodiment is characterized in that there are provided at least two fixing member bands extending in different directions so that the angle θ illustrated in FIGS. 4A and 4B forms a predetermined angle (e.g., 60° to 120°). Although not particularly limited, in the embodiments illustrated in FIGS. 4A and 4B, the first fixing member 60Da₁ and the second fixing member 60Db₁ are further provided on parts of the main surfaces 103D of the electrode assembly 100D so as to be respectively continuous with the cut-away side surface 101D and the uncut-away side surface 102D. Further, in the embodiments illustrated in FIGS. 4A and 4B, the third fixing member 60Da₂ and the fourth fixing member 60Db₂ are further provided on parts of the main surfaces 103D of the electrode assembly 100D so as to be respectively continuous with the cut-away side surface 101D and the uncut-away side surface 102D.

In this case, in this embodiment, in addition to the integral fixation of the end portions of the positive electrode, the negative electrode, and the separator exposed at both the side surfaces by the fixing members 60Da₁ and 60Db₁, the fixation by sandwiching one main surface 103D and the other main surface 103D of the electrode assembly 100D by the fixing members 60Da₁ and 60Db₁ is performed. Accordingly, in this embodiment, in addition to the integral fixation of the end portions of the positive electrode, the negative electrode, and the separator exposed at both the side surfaces by the fixing members 60Da₂ and 60Db₂, the fixation by sandwiching one main surface 103D and the other main surface 103D of the electrode assembly 100D by the fixing members 60Da₂ and 60Db₂ is further performed.

The integral fixation and the fixation by sandwiching are performed by the fixing members 60Da₁ and 60Db₁ and the fixing members 60Da₂ and 60Db₂, so that it is firstly possible to suitably suppress the separation along the stacking direction of layers of the positive electrode, the negative electrode, and the separator, which are exposed at both the cut-away side surface 101D and the uncut-away side surface 102D. Further, the integral fixation and the fixation by sandwiching are performed, so that it is secondly possible to suitably suppress the positional deviation among the layers along the direction substantially perpendicular (substantially horizontal direction) to the stacking direction (substantially vertical direction) of the positive electrode, the negative electrode, and the separator.

Furthermore, in the exemplary embodiments illustrated in FIGS. 2A and 2B, when, in an electrode assembly 100B having a cut-away portion 30B in a planar view, a predetermined portion of the electrode assembly 100B which is fixed by a fixing member 60B is compared with a portion other than the predetermined portion of the electrode assembly 100B which is not fixed by the fixing member 60B, a direction in which the fixing force of the fixing member 60B acts on the electrode assembly 100B can be one direction due to the fact that only the predetermined portion is fixed by the fixing member 60B. This indicates that there is a possibility that the fixing force of the fixing member 60B on the electrode assembly 100B does not suitably act on the portion other than the predetermined portion of the electrode assembly 100B which is not fixed by the fixing member 60B (a cut-away side surface in a different region of the electrode assembly 100B forming the cut-away portion 30B, a uncut-away side surface opposed to the cut-away side surface or the like).

As described above, in this embodiment, as compared with the embodiments illustrated in FIGS. 2A and 2B, there are provided at least two fixing member bands 80D₁ and 80D₂ extending in different directions so that the angle θ illustrated in FIGS. 4A and 4B forms a predetermined angle (e.g., 60° to 120°). As a result of providing the fixing member bands 80D₁ and 80D₂, the fixing forces on the electrode assembly 100D by the first fixing member 60Da₁ for fixing the cut-away side surface 101D forming the fixing member band 80D₁ and the second fixing member 60Db₁ for fixing the uncut-away side surface 102D are influenced by the fixing forces on the electrode assembly 100D by the third fixing member 60Da₂ for fixing the cut-away side surface 101D forming the fixing member band 80D₂ and the fourth fixing member 60Db₂ for fixing the uncut-away side surface 102D, whereby it is possible to provide a substantially balanced fixing force throughout the electrode assembly 100D rather than a localized portion of the electrode assembly 100D.

In this embodiment, it is more preferable to provide at least two fixing member bands 80D₁ and 80D₂ extending in different directions so that the angle θ illustrated in FIGS. 4A and 4B forms 90°. Thus, the inner product of a vector in which the fixing forces of the first fixing member 60Da₁ and the second fixing member 60Db₁ act on the electrode assembly 100D and a vector in which the fixing forces of the third fixing member 60Da₂ and the fourth fixing member 60Db₂ act on the electrode assembly 100D is zero, and θ is equal to 90°. Accordingly, it is possible to provide a suitably balanced fixing force throughout the electrode assembly 100D according to the exemplary embodiment.

The substantially balanced fixing force throughout the electrode assembly 100D is provided, so that the separation along the stacking direction of layers is still more suitably suppressed as described herein and the positional deviation among the layers along the direction substantially perpendicular (substantially horizontal direction) to the stacking direction (substantially vertical direction) is still more suitably suppressed as also described herein. Thus, it is possible to still more suitably maintain the strength of an end portion region 70D of the electrode assembly 100D forming a cut-away portion 30D. The strength of the end portion region 70D of the electrode assembly 100D is more suitably maintained, so that it is possible to still more suitably suppress the occurrence of local bending in the end portion region 70D of the electrode assembly 100D forming the cut-away portion 30D.

It is noted that the exemplary embodiments illustrated in FIGS. 4A and 4B are merely examples, and, for example, the embodiments illustrated in FIGS. 4C and 4D may be adopted on the premise that it is possible to provide the substantially balanced fixing force throughout the electrode assembly.

FIGS. 4C and 4D are plan views schematically illustrating modifications of FIGS. 4A and 4B.

In an example, as illustrated in FIG. 4C, a first fixing member 60Ea₁ for fixing a cut-away side surface 101E and a second fixing member 60Eb₁ for fixing a uncut-away side surface 102E may be arranged so as to be deviated from and opposed to each other in a planar view. Similarly, as illustrated in FIG. 4C, a third fixing member 60Ea₂ for fixing the cut-away side surface 101E and a fourth fixing member 60Eb₂ for fixing the uncut-away side surface 102E may be arranged so as to be deviated from and opposed to each other in a planar view.

In another example, as illustrated in FIG. 4D, a first fixing member 60Fa₁ for fixing a cut-away side surface 101F and a second fixing member 60Fb₁ for fixing a uncut-away side surface 102F are opposed to each other in a planar view, and the dimension of one fixing member (the second fixing member 60Fb₁) may be relatively larger than the dimension of the other fixing member (the first fixing member 60Fa₁). Similarly, as illustrated in FIG. 4D, a third fixing member 60Fa₂ for fixing the cut-away side surface 101F and a fourth fixing member 60Fb₂ for fixing the uncut-away side surface 102F are opposed to each other in a planar view, and the dimension of one fixing member (the third fixing member 60Fa₂) may be relatively larger than the dimension of the other fixing member (the fourth fixing member 60Fb₂).

Meanwhile, it is more preferable to employ the embodiment illustrated in FIG. 4E in which the embodiment illustrated in FIGS. 3A and 3B are combined with the embodiments illustrated in FIGS. 4A and 4B.

The embodiment illustrated in FIG. 4E is characterized in that a first fixing member 60Ga₁ for fixing a cut-away side surface 101G and a second fixing member 60Gb₁ for fixing a uncut-away side surface 102G are continuous through main surfaces 103G of an electrode assembly 100G. Additionally, the embodiment illustrated in FIG. 4E is characterized in that a third fixing member 60Ga₂ for fixing the cut-away side surface 101G and a fourth fixing member 60Gb₂ for fixing the uncut-away side surface 102G are continuous through the main surfaces 103G of the electrode assembly 100G.

According to these characteristics, in the embodiment illustrated in FIG. 4E, the fixing member 60Ga₁ and the fixing member 60Cb₁ (i.e., a fixing member 60G₁) are provided so as to entirely surround the cut-away side surface 101G, the uncut-away side surface 102G, and the main surfaces 103G of the electrode assembly 100G in a sectional view, as compared with the embodiments illustrated in FIGS. 2A and 2B. Further, the fixing member 60Ga₂ and the fixing member 60Cb₂, (i.e., a fixing member 60G₂) are provided so as to entirely surround the cut-away side surface 101G, the uncut-away side surface 102G, and the main surfaces 103G of the electrode assembly 100G in a sectional view. As a result, the electrode assembly 100G at portions where the fixing members 60G₁ and 60G₂ are provided is entirely surrounded by the fixing members 60G₁ and 60G₂ in a sectional view, whereby the fixation of the electrode assembly 100G at the portions can be further enhanced.

Additionally, it is more preferable to provide the fixing members 60G₁ and 60G₂ (in the case of the continuous form, each of the fixing members corresponds to the fixing member band) extending in different directions so that the angle θ illustrated in FIG. 4E forms 90°. Thus, the inner product of a vector in which the fixing force acts on the electrode assembly 100G by the fixing member 60G₁ (or also referred to as “fixing member band”) and a vector in which the fixing force acts on the electrode assembly 100G by the fixing member 60G₂ (or also referred to as “fixing member band”) is zero, and θ is equal to 90°. Accordingly, it is possible to provide a suitably balanced fixing force throughout the electrode assembly 100G.

In an exemplary embodiment, it is preferable to further provide a fixing member band extending in substantially the same direction as the extending direction of the fixing member band.

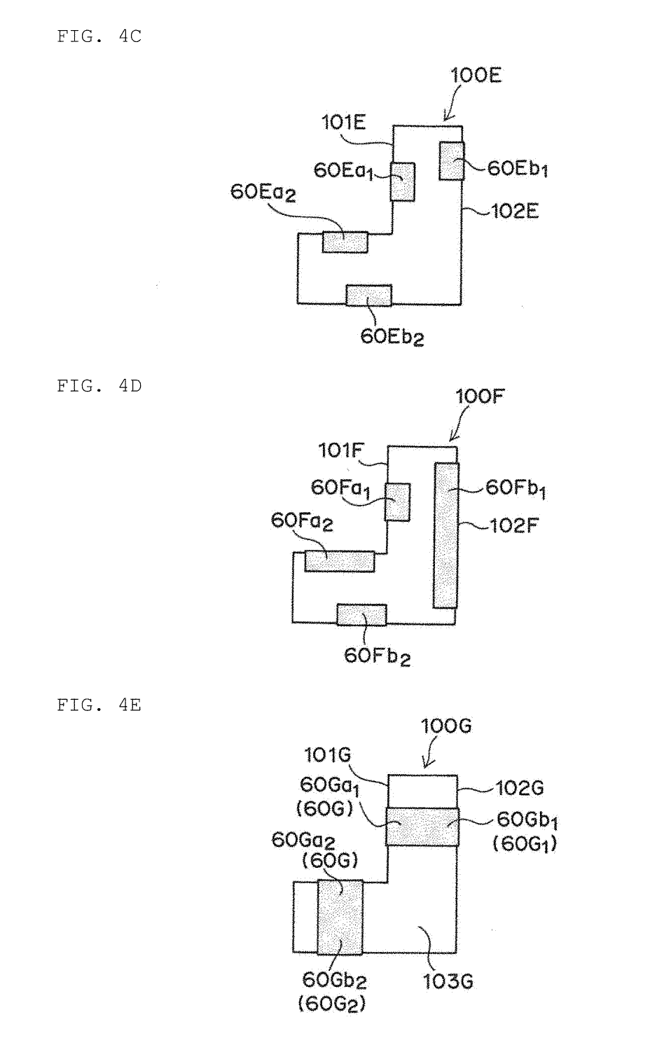

FIGS. 5A and 5B are plan views schematically illustrating an embodiment in which a fixing member band extending in substantially the same direction as the extending direction of the fixing member band is further provided.

The embodiment illustrated in FIG. 5A is different from the embodiment illustrated in FIG. 4A in that the number of fixing member bands extending in a predetermined direction is at least two (fixing member bands 80H₁ and 80H₂ in the illustrated embodiment) and the number of fixing member bands extending in a direction different from the predetermined direction is at least two (fixing member bands 80H₃ and 80H₄ in the illustrated embodiment). Such a difference makes it possible to provide a substantially balanced fixing force throughout an electrode assembly 100H, and the number of fixing member bands is relatively larger than that in the embodiment illustrated in FIG. 4A, as a result of which it is possible to further improve the fixing force on the electrode assembly 100H.

The embodiment illustrated in FIG. 5B is different from the embodiment illustrated in FIG. 5A in that the fixing member in the continuous form corresponding to the fixing member band is in the continuous form instead of the discontinuous form. In addition to being able to provide a substantially balanced fixing force throughout an electrode assembly 100I due to the difference, the number of the fixing members corresponding to the fixing member bands is relatively large, whereby the fixing force on the electrode assembly 100I is further improved, and the electrode assembly 100I at portions where fixing members 60I₁ to 60I₄ are provided is entirely surrounded by the fixing members 60I₁ to 60I₄ in a sectional view, whereby the fixation of the electrode assembly 100I at the portions can be further enhanced.

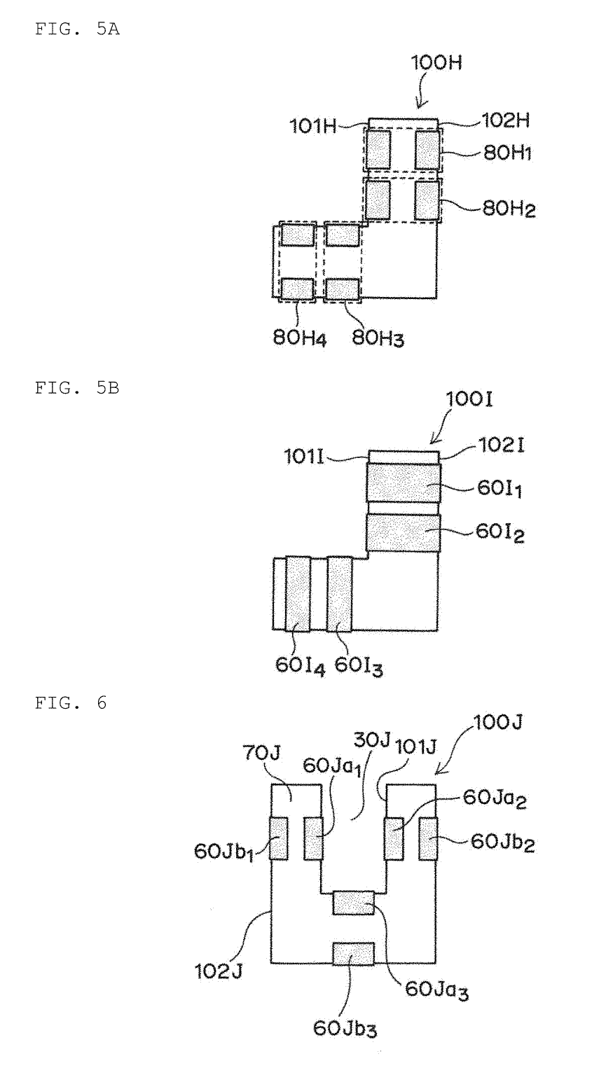

The shape of the cut-away portion in a planar view of the electrode assembly is not limited to those illustrated in FIGS. 1A to 5B. For example, it is possible to employ the embodiment illustrated in FIG. 6. In the embodiment illustrated in FIG. 6, similarly to the above-described embodiments, fixing members 60Ja₁ to 60Ja₃ for fixing a cut-away side surface 101J of an electrode assembly 100J which forms a cut-away portion 30J as well as fixing members 60Jb₁ to 60Jb₃ for fixing a uncut-away side surface 102J of the electrode assembly which is opposed to the cut-away side surface 101J and forms a part other than the cut-away portion 30J may be provided from the viewpoint of suitably suppressing the occurrence of local bending in an end portion region 70J of the electrode assembly 100J which forms the cut-away portion 30J.

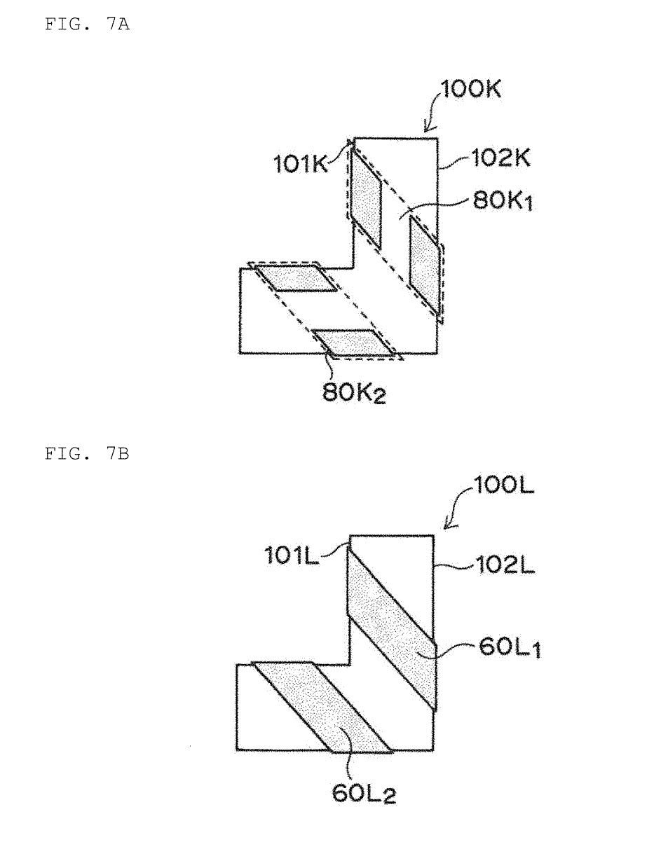

For example, the following exemplary embodiments can be adopted on the premise of the characteristics that there are provided fixing members for fixing at least a cut-away side surface of an electrode assembly and an uncut-away side surface of the electrode assembly. Specifically, as illustrated in FIG. 7A, at least two fixing member bands for fixing a cut-away side surface 101K and a uncut-away side surface 102K of an electrode assembly 100K may be provided in a planar view, and a fixing member band 80K₁ (as one of the fixing member bands) and a fixing member band 80K₂ (as the other fixing member band) may be provided substantially in parallel. In this case, one fixing member located on the side of the cut-away side surface in each of the fixing member bands and the other fixing member located on the side of the uncut-away side surface in each of the fixing member bands are in a deviated form so as to be opposed to each other in a planar view. Further, as illustrated in FIG. 7B, at least two fixing members in a continuous form (i.e., corresponding to fixing member bands) for a fixing cut-away side surface 101L and a uncut-away side surface 102L of an electrode assembly 100L may be provided in a planar view, and a fixing member 60L₁ (as one of the fixing member bands) and a fixing member 60L₂ (as the other fixing member band) may be provided substantially in parallel.

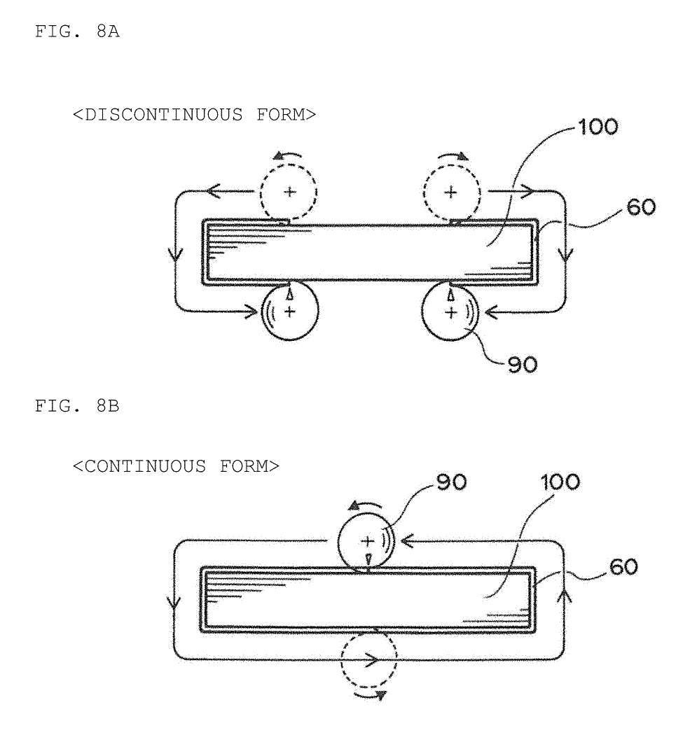

Finally, the following facts will be added in a confirmed manner. As an example, a fixing member 60 in a discontinuous form (a fixing member made of an insulating tape) can be provided by rolling a roller 90 on which the insulating tape is wound along at least both side surfaces of an electrode assembly 100 in a sectional view (see FIG. 8A). Meanwhile, the fixing member 60 in a continuous form (a fixing member made of an insulating tape) may be provided by rolling the roller 90 on which the insulating tape is wound so as to surround the surface forming the electrode assembly 100 in a sectional view (see FIG. 8B).

In general, it is noted that the secondary battery according to an exemplary embodiment of the present disclosure can be used in various fields in which electricity storage is expected. Although the followings are merely examples, the secondary battery according to an embodiment of the present invention, particularly the nonaqueous electrolyte secondary battery can be used in electricity, information and communication fields where mobile devices are used (e.g., mobile device fields, such as mobile phones, smartphones, laptop computers, digital cameras, activity trackers, ARM computers, and e-paper), domestic and small industrial applications (e.g., the fields such as power tools, golf carts, domestic robots, caregiving robots, and industrial robots), large industrial applications (e.g., the fields such as forklifts, elevators, and harbor cranes), transportation system fields (e.g., the fields such as hybrid cars, electric cars, buses, trains, electric assisted bicycles, and two-wheeled electric vehicles), electric power system applications (e.g., the fields such as various power generation systems, load conditioners, smart grids, home-installation type power storage systems), IoT applications, and space and deep sea applications (e.g., the fields such as spacecrafts and research submarines).

### DESCRIPTION OF REFERENCE SYMBOLS

10A: Positive electrode
10B: Negative electrode
11A: Positive electrode current collector
11B: Negative electrode current collector
12A: Positive electrode material layer
12B: Negative electrode material layer
30A, 30B, 30C, 30D, 30J: Cut-away portion
30′: Cut-away portion (conventional)
50: Separator
60, 60C, 60G₁, 60G₂, 60I₁, 60I₂, 60I₃, 60I₄, 60L₁, 60L₂: Fixing member
60a, 60Aa, 60Ba, 60Ca, 60Da₁, 60Da₂, 60Ea₁, 60Ea₂, 60Fa₁, 60Fa₂, 60Ga₁, 60Ga₂, 60Ja₁, 60Ja₂, 60Ja₃: Fixing member for fixing cut-away side surface
60b, 60Ab, 60Bb, 60Cb, 60Db₁, 60Db₂, 60Eb₁, 60Eb₂, 60Fb₁, 60Fb₂, 60Gb₁, 60Gb₂, 60Jb₁, 60Jb₂, 60Jb₃: Fixing member for fixing uncut-away side surface
61D: Insulating tape-like fixing member
62D: Fitting member
70, 70A, 70B, 70C, 70D, 70J: End portion region of electrode assembly (in a planar view)
70′: End portion region of electrode assembly (in a planar view) (conventional)
80, 80D₁, 80D₂, 80H₁, 80H₂, 80H₃, 80H₄, 80K₁, 80K₂: Fixing member band
90: Roller
100, 100A, 100B, 100C, 100D, 100E, 100F, 100G, 100H, 100I, 100J, 100K, 100L: Electrode assembly
100′: Electrode assembly (conventional)
101, 101A, 101B, 101C, 101D, 101E, 101F, 101G, 101H, 101I, 101J, 101K, 101L: Cut-away side surface of electrode assembly
102, 102A, 102B, 102C, 102D, 102E, 102F, 102G, 102H, 102I, 102J, 102K, 102L: Uncut-away side surface of electrode assembly
103, 103B, 103C, 103D, 103G: Main surface of electrode assembly
200′: Exterior body (conventional)
300′: Secondary battery (conventional)
θ: Angle formed between extending direction of one fixing member band and extending direction of the other fixing member band

1. A secondary battery comprising:
an electrode assembly including a positive electrode, a negative electrode, and a separator disposed therebetween; and
an electrolyte,
wherein the electrode assembly and the electrolyte are accommodated in an exterior body,
wherein the electrode assembly has a planar stacked structure in which a plurality of electrode configuration layers, which include the positive electrode, the negative electrode, and the separator, are planarly stacked in a sectional view thereof,
wherein the electrode assembly comprises a cut-away portion in a planar view thereof, and
wherein the electrode assembly further comprises fixing members configured to fix at least a cut-away side surface of the electrode assembly that forms the cut-away portion and a uncut-away side surface of the electrode assembly that opposes the cut-away side surface.

2. The secondary battery according to claim 1, wherein the fixing members are disposed on portions of respective main surfaces of the electrode assembly and are continuous with the cut-away side surface.

3. The secondary battery according to claim 2, wherein the fixing members are further disposed on portions of respective main surfaces of the electrode assembly and are continuous with the uncut-away side surface.

4. The secondary battery according to claim 3, wherein a respective fixing member configured to fix the cut-away side surface and a respective fixing member configured to fix the uncut-away side surface are discontinuous through the main surface of the electrode assembly.

5. The secondary battery according to claim 3, wherein a respective fixing member configured to fix the cut-away side surface and a respective fixing member configured to fix the uncut-away side surface are continuous through the main surface of the electrode assembly.

6. The secondary battery according to claim 1, further comprising at least two fixing member bands of the fixing members, with an angle formed between an extending direction of a first fixing member band and an extending direction of a second fixing member band being from 60° to 120° in the planar view thereof.

7. The secondary battery according to claim 6, wherein the angle between the respective extending directions is 90° in the planar view thereof.

8. The secondary battery according to claim 6, wherein the first fixing member band extends in substantially a same direction as the extending direction of the second fixing member band.

9. The secondary battery according to claim 1, wherein the positive electrode and the negative electrode have a layer configured for occluding and releasing lithium ions.

10. A secondary battery comprising:
an exterior body;
an electrolyte accommodated in the exterior body;
an electrode assembly accommodated in the exterior body and having a planar stacked structure comprising a plurality of electrode configuration layers each with a positive electrode, a negative electrode, and a separator stacked in a sectional view thereof, with the electrode assembly having a cut-away portion in a planar view thereof; and
a plurality of fixing members respectively disposed at least on a first side surface of the electrode assembly forms the cut-away portion and a second side surface of the electrode assembly that opposes the first side surface.

11. The secondary battery according to claim 10, wherein the plurality of fixing members are disposed on portions of respective main surfaces of the electrode assembly and are continuous with the first side surface.

12. The secondary battery according to claim 11, wherein the respective main surfaces of the electrode assembly are disposed orthogonally to the first and second side surfaces in the sectional view thereof.

13. The secondary battery according to claim 11, wherein the fixing members are further disposed on portions of the respective main surfaces of the electrode assembly and are continuous with the second side surface.

14. The secondary battery according to claim 13, wherein a respective fixing member configured to fix the first side surface and a respective fixing member configured to fix the second side surface are discontinuous through one of the main surfaces of the electrode assembly.

15. The secondary battery according to claim 13, wherein a respective fixing member configured to fix the first side surface and a respective fixing member configured to fix the second side surface are continuous through one of the main surfaces of the electrode assembly.

16. The secondary battery according to claim 11, wherein the plurality of fixing members comprise at least two fixing member bands, with an angle formed between an extending direction of a first fixing member band and an extending direction of a second fixing member band being from 60° to 120° in the planar view thereof.

17. The secondary battery according to claim 16, wherein the angle between the respective extending directions is 90° in the planar view thereof.

18. The secondary battery according to claim 16, wherein the first fixing member band extends in substantially a same direction as the extending direction of the second fixing member band.

19. The secondary battery according to claim 11, wherein the positive electrode and the negative electrode have a layer configured for occluding and releasing lithium ions.

20. The secondary battery according to claim 11, wherein the electrode assembly having the cut-away portion comprises an L-shaped surface in the planar view thereof.
